(19) United States
(12) Patent Application Publication
(10) Pub. No.: US 2009/0278396 A1
(43) Pub. Date: Nov. 12, 2009

(54) CORROSION ISOLATION OF MAGNESIUM COMPONENTS

(75) Inventors: Paul E. Krajewski, Sterling Heights, MI (US); Mark W. Verbrugge, Troy, MI (US); Anil K. Sachdev, Rochester Hills, MI (US); James G. Schroth, Troy, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., DETROIT, MI (US)

(21) Appl. No.: 12/118,881

(22) Filed: May 12, 2008

(51) Int. Cl. B60B 19/00

(52) U.S. Cl. 301/5.1

(57) ABSTRACT

A vehicle component, such as a wheel, is formed of a magnesium alloy for weight reduction in an automotive vehicle. It is expected that the wheel will be attached to other vehicle wheel-related componenets that are formed of metal compositions (for example, steel or cast iron components) that may lead to the corrosion of the magnesium wheel. Such attachment surfaces of the magnesium wheel are oxidized to form an integral and durable oxide layer on the magnesium wheel. When the magnesium wheel is attached to vehicle wheel supporting components of other alloys, the oxide layer-coated surfaces of the magnesium wheel are electrochemically isolated from the non-magnesium materials to prevent oxidation of the wheel or attached components.

### TECHNICAL FIELD

This invention pertains to the adaptation of magnesium components such as automotive vehicle wheels for corrosion isolation from contiguous vehicle parts formed of other materials such as cast iron or steel. Integral oxide layers are formed on surfaces of, for example, magnesium wheels to isolate the wheels from direct surface-to-surface contact with attached different metal parts.

### BACKGROUND OF THE INVENTION

There is interest in reducing vehicle mass by making magnesium alloy wheels (and other magnesium vehicle components) for automotive vehicles. Reducing vehicle unsprung mass has additional importance (i.e., beyond that of reducing mass for improving fuel economy) in that it improves vehicle ride characteristics. However, the wheels are attached to wheel hubs, brake rotors, spindles, and the like that are not formed of a magnesium alloy. Magnesium tends to form a corrosive galvanic coupling with other metals, such as ferrous alloys, particularly when the attached parts are exposed to air, water and salt.

One strategy to minimize corrosion of a magnesium wheel is to cast a portion of the magnesium wheel in interlocking engagement around a preformed aluminum alloy insert. A ferrous metal hub or spindle is then attached to the aluminum insert piece. The aluminum insert isolates the magnesium wheel body from iron-based parts but complicates the wheel making process and adds cost to the wheels. In addition, because the density of aluminum (2.70 g/cc) is larger than that of magnesium (1.74 g/cc), the aluminum portions of the wheel add mass relative to a strictly magnesium alloy construction.

There remains a need for a method of making magnesium wheels and other magnesium vehicle components that enables them to be isolated from electrochemical interaction with other vehicle components that form corrosive couples with magnesium alloys.

### SUMMARY OF THE INVENTION

In one embodiment of the invention a magnesium wheel is formed that is shaped for attachment to a vehicle wheel hub member, spindle member, or other non-magnesium vehicle wheel component. The magnesium wheel may be made, for example, by casting with AM60B or AZ91 magnesium alloys or forging an AZ80 alloy. The magnesium wheel is shaped with lug holes and/or other complementary contact surfaces for attachment to other members of a vehicle wheel mechanism. Often, for example, a wheel is bolted to a vehicle wheel hub or brake rotor component. Also the wheel may be attached to a wheel spindle. Holes may be formed in the magnesium wheel to receive lug nuts of the hub or rotor and to receive the spindle. These other vehicle wheel members are often made of steel or iron alloys that may form an electrochemical coupling when they are in direct contact with the magnesium alloy wheel. Such a coupling often results in corrosive degradation of the magnesium wheel because magnesium is anodic to iron and other materials used in vehicle wheel assemblies.

In accordance with embodiments of this invention, a durable oxide conversion coating is formed electrolytically (anodically) on at least those surfaces of the magnesium wheel that are anticipated to be contacted with such a non-magnesium vehicle wheel component. The coating is a magnesium-containing, highly compact oxide layer, integral with the magnesium alloy substrate. The oxide coating may be formed to a thickness up to about 150 micrometers or so to provide its electrical (electrochemical) isolation function. The compact oxide layer is dense, hard, and continuous and effectively isolates the magnesium surface from an attached non-magnesium component. The coating may be crystalline. To the extent that the coating contains pores they are not interconnected to the extent that the isolation function of the coating is impaired. The coating provides protection against wear and galvanic corrosion at the interface of the wheel with other wheel components of dissimilar composition. The oxide coating may contain very small (nanometer size) particles that add to the desirable properties of the corrosion isolation coating on the magnesium wheel surface(s). Such an oxide coating eliminates the need for a separately formed corrosion-impeding insert (for example, an aluminum alloy insert) formed for placement between a magnesium wheel body and another non-magnesium component of the wheel assembly.

In forming oxide layers on magnesium alloys, species may be added to the electrolyte that give rise to color, hues, or other pleasing appearance characteristics that are noticeable on the magnesium wheel. Metal ions in the electrolyte (e.g., tin ions), for example, may be added, which, upon current reversal during the oxide deposition process lead to metal deposition (e.g., tin deposition), and coloration. Similarly, dyes can be codeposited to give rise to pleasing coloration.

In one embodiment, the oxide conversion coating may be formed on selected surfaces of the magnesium alloy wheel by a plasma electrolytic oxidation process, sometimes called micro arc oxidation. In this embodiment of the invention, selected areas of the wheel are contacted with an oxidizing aqueous alkaline electrolyte. The process comprises the use of high-frequency alternating current pulses of a certain form and having a given frequency range to form the integral oxide layer. This current pattern form may be combined with the generation of acoustic vibrations in a sonic frequency range in the electrolyte. Preferably the frequency ranges of the current pulses and the acoustic vibrations are overlapping. The process makes it possible to introduce ultra-disperse powders into the electrolyte, with the acoustic vibrations helping to form a stable hydrosol, and to create coatings with experimentally predetermined properties for protection of the magnesium wheel and attached components. The process makes it possible to produce dense hard microcrystalline ceramic coatings of thickness up to 150 microns or more. The coatings are characterized by reduced specific thickness of an external porous layer (less than 14% of the total coating thickness) and low roughness of the oxidized surface, Ra 0.6-2.1 microns.

However formed, the compact and integral oxide layer isolates the magnesium alloy material of the wheel (or other vehicle component) from attached vehicle components of other compositions to prevent or minimize corrosion of either part.

Other objects and advantages of the invention will be apparent from a detailed description of an illustrative embodiment which follows in this specification.

### BRIEF DESCRIPTION OF THE DRAWINGS

The drawing FIGURE is a cross-sectional view of a magnesium wheel for an automotive vehicle. Surfaces of the wheel to be attached to other vehicle components have an integral oxide coating that isolates the magnesium alloy from an attached component of dissimilar composition.

### DESCRIPTION OF PREFERRED EMBODIMENTS

The drawing FIGURE shows a cross-sectional view of a vehicle wheel 10 which may be formed, for example, of a magnesium alloy formulated for casting or for forging. This includes, but is not limited to alloys such as AZ31B, AZ61A, AZ80A, ZK21, ZK31, ZK60, and ZM21.

Magnesium wheel 10 has a hub 12 that extends radially from the intended axis of rotation 14 of the wheel. Hub 12 terminates in a round circumferential rim 16. A pneumatic tire will typically be mounted on the radially exterior side 18 of rim 16. The radially interior side 20 of rim 16 and the inboard side 22 of wheel hub 12 define a space 23 to receive other vehicle wheel components (not shown in the FIGURE) when wheel 10 is mounted on a spindle or axle of a vehicle wheel system. In some vehicles wheel 10 may also be mounted to a wheel hub or to a brake rotor. In the illustrative example of the drawing FIGURE, hub 12 of wheel 10 has an axial hole 24 for the end of a wheel spindle (not shown in the FIGURE) and a plurality of holes 26 for wheel hub lug bolts (not shown). Lug bolt holes 26 are located on a circle radially outwardly on hub 12 from spindle hole 24. Typically four or five lug bolt holes are formed in a wheel and the axially outer ends of the holes may include a chamfer 28 to receive a lug nut to fix wheel 10 to a vehicle wheel hub.

Wheel spindles, hub lug nuts, and other vehicle wheel components are often formed of a steel alloy or cast iron alloy for strength and durability. Corrosion of magnesium alloy wheel 10 is likely to occur where these ferrous compositions contact the wheel. Corrosion of more anodic material at the contacting surfaces (typically the magnesium wheel) is more likely when contacting surfaces of dissimilar metals are exposed to water and salt. In accordance with this invention, surfaces of magnesium alloy wheel 10 that are contacted with an iron or steel wheel member are coated with a relatively thick, durable, compact oxide layer 30. Oxide layer 30 is formed integrally with selected surfaces of magnesium alloy wheel 10 and the oxide layer 30 (or its equivalent) isolates its underlying magnesium surfaces from electrochemical contact with any component of dissimilar composition engaging wheel 10.

In the wheel embodiment illustrated in the drawing FIGURE, oxide layer 30 is formed on the surfaces of spindle hole 24, lug holes 26, chamfer surfaces 28, and adjacent axially outer surfaces 32 of wheel hub 12. Oxide layer 30 is also formed on surfaces of the inboard-side 22 of hub 12 that are expected to be in face-to face contact with a ferrous brake rotor or the like. The use of a protective and isolating oxide layer 30 on a magnesium wheel permits the elimination of, for example, an aluminum insert body between a portion of a magnesium wheel and contacting ferrous metal vehicle components. In other words, more of the structure of wheel 10 may be formed of light weight magnesium alloy. The structure of the wheel is simplified as is its method of manufacture.

Oxide coating 30 is suitably formed anodically and integrally with selected surfaces of magnesium composition of wheel 10 by electrolytic oxidation of the magnesium alloy surface. Such a resulting oxide surface conversion coating 30 may include magnesium and other elements of the magnesium alloy wheel surface. The oxide coating may also include materials, such as nanometer size, hard alumina particles or silicon carbide particles, introduced or deposited when selected magnesium alloy wheel surfaces are oxidized.

In accordance with an embodiment of the invention, the integral oxide layer may be formed by exposing wheel surfaces as an oxidizing electrode to a suitable alkaline electrolyte in an electrolytic oxidation process. A suitable electrolytic oxidation process is known as plasma electrolytic oxidation and is described in U.S. Pat. No. 6,896,785. An example of such an oxidation process follows.

The magnesium alloy wheel may be masked except for areas to be protected with an oxide coating. The wheel is connected with an electrode and placed in contact with an electrolytic bath fitted with a counter-electrode and filled with aqueous alkaline electrolyte. In some embodiments the electrode(s) may be shaped to focus current density and anodic activity to selected coating areas and eliminate a masking of the wheel or other component. The electrolyte may be an aqueous solution of phosphates and aluminates at a pH of about 12.5 and initially at about 25° C. A pulsed current of high-frequency bipolar pulses having a predetermined frequency range is supplied across the electrodes so as to enable the process to be conducted in a plasma-discharge regime. At the same time, acoustic vibrations are generated in the electrolyte in a predetermined sonic frequency range so that the frequency range of the acoustic vibrations overlaps with the frequency range of the current pulses. The electrolyte may, for example, be circulated through spindle hole 24 and lug nut holes 26 and over surfaces 32 of a magnesium wheel such as wheel 10 in the drawing FIGURE.

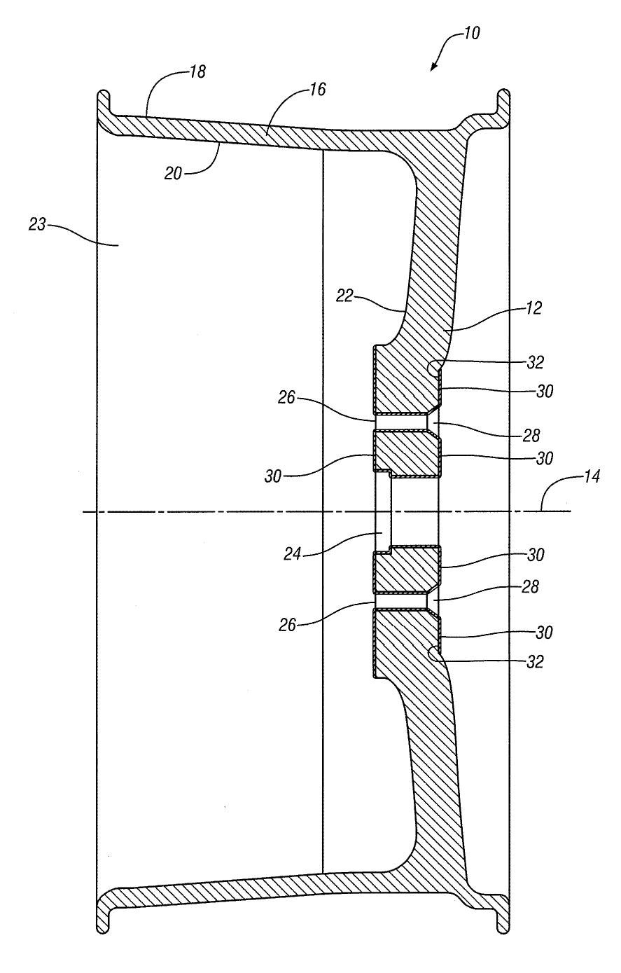

The combined alternating current pulses and sonic pulses are continued to form an oxidized coating of a required thickness in a plasma-discharge regime, which is preferably a plasma electrolytic oxidation regime. For example, a pulsed current may be created in the bath with a pulse succession frequency of 500 Hz or more, preferably 1000 to 10,000 Hz, with a preferred pulse duration of 20 to 1,000 microseconds. Each current pulse advantageously has a steep front (as illustrated, for example, in FIG. 1 of the '785 patent) so that the maximum amplitude is reached in not more than 10% of the total pulse duration, and the current then falls sharply, after which it gradually decreases to 50% or less of the maximum. The current density is preferably 3 to 200 A/dm², even more preferably 10 to 60 A/dm².

The acoustic vibrations may be generated in the electrolyte by an aero-hydrodynamic generator, the generator creating acoustic vibrations in the bath in a sonic frequency range that overlaps with a current pulse frequency range.

Ultra-disperse powders (nanometer size powders) of oxides, borides, carbides, nitrides, silicides and sulphides of metals of particle size not more than 0.5 micrometer may be added to the electrolyte, and a stable hydrosol may be formed with the aid of the acoustic vibrations.

Brief pulses with high current values make it possible to create sparks in plasma discharge channels formed in the coating which are considerably higher in power than the power for low-frequency regimes. The higher temperatures in the plasma discharge channels, along with the more rapid cooling and solidifying of the molten substrate due to decreased micro-volumes, leads to the formation of dense microcrystalline ceramic coatings with a high content of solid high-temperature oxide phases. The microhardness of the oxide coatings may reach 500 to 2100 HV. The hard continuous oxide coating is characterized by an external porous layer. The thickness of the external porous layer preferably does not exceed 14% of the total thickness of the coating.

Other methods of anodically forming a protective, compact integral oxide layer on a magnesium component may be used.

However formed, it is preferred that the integral oxide coating, like coating 30, for a magnesium alloy wheel, like wheel 10, have a thickness of at least about 75 micrometers and, more preferably, of at least 100 micrometers.

Practices of the invention have been illustrated by the formation of an oxide coating on a magnesium alloy wheel. This is an important embodiment of the invention because magnesium wheels may be securely attached in face-to-face contact to non-magnesium vehicle components and vehicle wheels are expected to operate in a potentially corrosive environment of water, air, and sometimes salt. But, in addition to vehicle wheels, there are other vehicle components that may advantageously be made of a magnesium alloy, closely attached to non-magnesium components, and exposed to a like corrosive environment. Engine cradles and vehicle body components are examples of such components that may be isolated by an integral oxide layer from a facing surface of an attached non-magnesium part.

1. A vehicle component formed of a magnesium-base alloy and having a component surface to be engaged in surface-to-surface contact by a second vehicle component of dissimilar metal composition in a vehicle multi-metal vehicle component, the multi-metal vehicle component to be exposed to air and water in vehicle use;
each contacting surface of the magnesium alloy component surface having an integral oxide coating that electrochemically isolates the magnesium alloy surface from a contacting surface of the second vehicle component.

2. A vehicle component as recited in claim 1 in which the integral oxide coating has a thickness of at least 75 micrometers.

3. A vehicle component as recited in claim 1 in which the integral oxide coating is an electrolytic anodic coating formed to a thickness of about 75 micrometers or thicker.

4. A vehicle component as recited in claim 3 in which the integral oxide coating is decoratively colored.

5. A vehicle component as recited in claim 3 in which the integral oxide coating comprises nano-sized filler particles.

6. A vehicle wheel formed of a magnesium-base alloy and having wheel surfaces to be engaged in surface-to-surface contact by vehicle components of dissimilar metal compositions when the wheel is attached to a vehicle, each contacting surface of the magnesium alloy wheel having an integral oxide coating that electrochemically isolates the magnesium alloy surface from a contacting surface of a vehicle component.

7. A vehicle wheel as recited in claim 6 in which the integral oxide coating has a thickness of at least 75 micrometers.

8. A vehicle wheel as recited in claim 6 in which the integral oxide coating is an electrolytic anodic coating formed on the wheel surface to a thickness of about 75 micrometers or thicker.

9. A vehicle wheel as recited in claim 8 in which the integral oxide coating is decoratively colored.

10. A vehicle wheel as recited in claim 8 in which the integral oxide coating comprises nano-sized filler particles.

11. A multi-metal vehicle component formed of a magnesium-base alloy component and having a magnesium alloy surface attached in surface-to-surface contact with a second component of dissimilar metal composition in a vehicle multi-metal vehicle component, the multi-metal vehicle component to be exposed to air and water in vehicle use;
each contacting surface of the magnesium alloy component having an integral oxide coating that electrochemically isolates the magnesium alloy surface from a contacting surface of the second vehicle component.

12. A multi-metal vehicle component as recited in claim 11 in which the integral oxide coating has a thickness of at least 75 micrometers.

13. A multi-metal vehicle component as recited in claim 11 in which the integral oxide coating is an electrolytic anodic coating formed to a thickness of about 75 micrometers or thicker.

14. A multi-metal vehicle component as recited in claim 11 in which the magnesium-base alloy component is a wheel comprising an integral hub and rim and the hub of the wheel is attached to at least one vehicle component of dissimilar metal composition.

15. A multi-metal vehicle component as recited in claim 11 in which the magnesium-base alloy component is a wheel comprising an integral hub and rim and the hub of the wheel is attached with non magnesium-base alloy lug bolts to at least one vehicle component of dissimilar metal composition.
